(19) United States
(12) Patent Application Publication
(10) Pub. No.: US 2025/0216026 A1
(43) Pub. Date: Jul. 3, 2025

(54) Hinge & Method of Use Thereof

(71) Applicant: Jackson D Bishop, III, Castle Pines, CO (US)

(72) Inventor: Jackson D Bishop, III, Castle Pines, CO (US)

(21) Appl. No.: 18/401,629

(22) Filed: Dec. 31, 2023

(51) Int. Cl. F16M 13/02; E05D 3/02; E05D 5/02

(52) U.S. Cl. CPC F16M 13/022; E05D 3/02; E05D 5/0223; E05Y 2600/52; E05Y 2600/622; E05Y 2900/208

(57) ABSTRACT

A folding hinge comprising a first hinge leaf plate having knuckles and mounting holes for receiving mounting fasteners, a second hinge leaf plate having knuckles and rack mounting pins, a hinge barrel which is formed by the knuckles from each leaf plate, and a hinge pin to join and secure the two leaf plates together to form a completed hinge for use in hanging or mounting doors, screens, panels, or other types of covers to storage racks and storage rack systems.

### CROSS REFERENCE TO RELATED APPLICATION

This application claims priority to U.S. provisional application No. 63/436,568 filed Dec. 31, 2023, the entirety of which is included herein for reference.

### FIELD OF THE INVENTION

This invention generally relates to the field of hinge devices. Moreover, it pertains specifically to a new door hinge and related system and method of use thereof for attaching, hanging, and replacing doors, screens, and cover panels.

### BACKGROUND OF THE INVENTION

A variety of hinges and hinge based systems have long been used to attach, mount, fasten, or otherwise hang doors, screens, panels or other types of covers used to conceal, secure, enclose, separate or partition, one volume of space from another. “Volume of space” refers to rooms, hallways, storage areas, closets, cabinets, shelves, pantries, offices, or virtually any area within an environment that can be divided from another are or otherwise enclosed.

Prior art hinges are often comprised of typical hinge components including two leafs, a barrel, and a center pin. A hinge leaf is the portion of the hinge that extends laterally from the center pin. The leaf generally revolves around the center pin. Typical hinges have two leafs, one left plate and one right plate. Both leaf plates typically have a multitude of screw holes to allow for one leaf plate to be attached to the door and the other leaf plate to be attached to a frame. Leaf plates also typically have cylinders attached to one side known as knuckles. A knuckle is a hollow cylindrical through which the pin passes when it is inserted. The knuckles of each leaf interlock to create a single barrel. The barrel is the center assembly of knuckles that connects the two leaf plates together and holds them in position when the center pin is inserted. The center pin securely retains the knuckles from each leaf plate in an interlocked position, and further serves as the central pivot point of each leaf plate.

While hinges have long been used to attach, mount, fasten, or otherwise hang doors, screens, panels or other types of covers, there are serious deficiencies and inadequacies with the prior art hinges. The majority of prior art hinges are deficient or inadequate due to the fact that they are limited to applications allowing for only screws or fasteners to be used to mount or attach them. While there are hinges that allow for fasteners such as through bolting with carriage bolts or similar types of bolts, these still require tools to attach and fasten the bolts and any associated hardware such as hex nuts. Still other types of prior art hinges allow for the use of adhesives to adhere the leaf plates to the door, panel, or frame; however, these types of adhesive hinges are severely limited in the amount of weight they can carry, and over time, the adhesive will deteriorate and weaken, especially with increased use.

Specifically, for applications related to attaching, mounting, fastening, or otherwise hanging doors, screens, panels, or other types of covers to storage racks and storage rack systems, the prior art hinges are deficient as they are not designed or intended to be used in this application. Screw based hinges cannot be used as there is no material through which to screw the leaf plate to without the significant effort of drilling through the storage rack steel support leg and thereby weakening the rack structure. While bolt-based hinges can be used, they require additional hardware, tools, and effort to attach the hinges in a consistent, level manner for proper operation of the hinges. Storage racks and storage rack systems typically embody horizontal shelves or cross members supported by and retained in position by the vertical support legs. Each vertical support leg further embodies openings (female) arrayed along the length of the support leg surfaces that are designed to receive pins (male) embodied in the horizontal shelves or cross members. The openings (female) arrayed along the length of the support leg surfaces are specifically designed to receive the pins (male), they are not designed to receive through bolts or other fastening hardware, and they are also not designed to receive through bolts based on the wide variety of hole spacings that exist in prior art hinges. The spacing of the slotted openings typically found on storage rack steel support legs will not accommodate traditional prior art hinges or the various sized hardware intended to be used with those hinges. Adhesive based hinges are not designed for use on the steel support legs typically embodied on storage racks and storage rack systems. The slotted openings arrayed on the face of the storage rack steel support legs greatly reduces the contact surface area on which any adhesive material relies for proper function and optimal strength of the hinge, thereby increasing the likelihood of failure.

There is therefore a need for a new hinge for attaching, mounting, or otherwise hanging doors, screens, panels, or other types of covers to storage racks and storage rack systems, which is specifically designed for use with the openings found on the steel support legs of a storage rack and storage rack system, and that will allow a user to quickly, easily, and removably attach, mount, or otherwise hang doors, screens, panels, or other types of covers to a storage rack or storage rack system, that will further save a user time and materials by connecting directly to the storage rack steel support leg without requiring the use of any tools or hardware, and in a manner that is not currently offered by prior art devices.

### SUMMARY OF THE INVENTION

The terms “invention”, “the invention”, and “the present invention” referred to in this patent are intended to refer broadly to all the subject matter of this patent. This summary is a high-level overview of various aspects of the invention and introduces some of the concepts that are further described in the Detailed Description section herein.

In view of the limitations now present in the prior art methods for attaching, mounting, fastening, or otherwise hanging doors, screens, panels, or other types of covers to storage racks and storage rack systems, the present invention provides an improved, new and useful hinge for attaching, mounting, or otherwise hanging doors, screens, panels, or other types of covers to storage racks and storage rack systems which is simpler in use, more universally functional and more versatile in application and operation than known prior art methods or devices.

The purpose of the present invention is to provide a new hinge for attaching, mounting, or otherwise hanging doors, screens, panels, or other types of covers to storage racks and storage rack systems. It is also a purpose of the present invention to provide a new hinge and method of use thereof that has many novel features not offered by the prior art, such as the ability to install doors, screens, panels, or other types of covers to storage racks and storage rack systems without requiring any additional tools or hardware, being designed specifically to engage with, and be supported by, the openings on steel legs of a storage rack or storage rack system, the ability to be used with different types of openings on different types of storage rack steel legs, the ability to quickly uninstall or change a door, screen, panel, or other type of cover on a storage rack and storage rack system, that results in a new and novel hinge for attaching, mounting, or otherwise hanging doors, screens, panels, or other types of covers to storage racks and storage rack systems, and method of use thereof. which is not apparent, obvious, or suggested, either directly or indirectly by any of the prior art devices, apparatus, or methods.

### DETAILED DESCRIPTION OF THE INVENTION

The present invention in the preferred embodiment comprises a main hinge body 10, said main hinge body further comprising first hinge leaf plate 15 and second hinge leaf plate 20, a hinge barrel 25, and a hinge pin 30. Said first hinge leaf plate 15 having a generally flat rectangular shape having generally planar front and back surfaces, said generally planar front and back surfaces connected by shorter, perpendicular, first, second, third, and fourth generally planar corresponding left, right, top, and bottom sides, thereby creating a generally flat rectangular shape typical of common hinge leaf plates. Said first hinge leaf plate 15 further comprising at least one knuckle 35, and a multitude of circular openings 40, or holes, said knuckle 35 having a generally cylindrical shape disposed generally along a length of one side of the generally flat rectangular hinge leaf plate 15, said multitude of circular openings 40, or holes, being generally disposed within the perimeter of the generally flat rectangular hinge leaf plate 15, said openings 40 extending, in a perpendicular manner, from the generally planar front surface, through the hinge leaf plate body, to the generally planar back surface, whereby the circular openings 40, or holes, are intended to allow for the passthrough of fasteners commonly used to attach a hinge leaf plate to a door, frame, panel, cover or other object or material intended to be operated with the hinge. Said second hinge leaf plate 20 having a generally flat rectangular shape having generally planar front and back surfaces, said generally planar front and back surfaces connected by shorter, perpendicular, first, second, third, and fourth generally planar corresponding left, right, top, and bottom sides, thereby creating a generally flat rectangular shape typical of common hinge leaf plates. Said second hinge leaf plate 20 further comprising at least one knuckle 35, and at least one rack attachment pin 50, said knuckle 35 having a generally cylindrical shape disposed generally along a length of one side of the flat rectangular leaf plate 20, whereby the knuckle 35 of the said first hinge leaf plate 15 and the knuckle 35 of the said second hinge leaf plate 20, interconnect to form said hinge barrel 25, through which the hinge pin 30 is inserted to pivotally interconnect said first hinge leaf plate 15 and second hinge leaf plate 20. Said rack attachment pin 50 generally comprising a pin shaft 55 and a pin head 60, said pin shaft protrudes from the generally planar back surface of the hinge leaf plate 20 a distance sufficient to dispose the pin head 60 from the hinge leaf plate back surface, said pin shaft 55 having, in the preferred embodiment, a generally cylindrical shape, said pin head 60 having, in the preferred embodiment, a generally cylindrical shape, said pin head further having a diameter greater than the diameter of the pin shaft.

The first hinge leaf plate 15, hinge barrel 25, and hinge pin 30 of the main hinge body 10 in the preferred embodiment, are intended to be typical common hinge components, further intended to attach, or fasten, to a door 85, frame, panel, cover, screen, or other object or material intended to be operated with the hinge. The unique and novel aspects of the invention are the rack attachment pin(s) 50 embodied in the second hinge leaf 20 plate that allow for the assembled main hinge body 10, and any door 85, frame, panel, cover or screen attached thereto, to be attached, mounted, or otherwise hung, to a front, back, side, or end face of a storage rack 70 or storage rack system by inserting the rack attachment pin head 50 through an opening 75 (female) embodied in, and arrayed along the length of, the rack support leg 80 surfaces. The new and novel hinge disclosed herein will enable a user to attach, mount, or otherwise hang a door 85, frame, panel, cover, screen, or other object or material intended to be operated with the hinge, to a storage rack 70 or storage rack system in a manner designed to work specifically with the various types and shapes of openings embodied in existing storage rack support legs 80.

In the preferred embodiment of the invention, the second hinge leaf plate 20, pin shaft 55, and pin head 60 of the rack attachment pin 50, are monolithic, meaning they are formed, cast, or otherwise manufactured as a single piece. However, it is to be understood that in alternate embodiments of the invention they may be manufactured as separate components and connected or fastened together by use of mechanical connectors or fasteners including but not limited in scope to, pins, rods, rivets, bolts, screws, anchors, embedments, inserts, welds, or adhesives, as well as other methods of connecting or fastening the rack attachment pin, or it's components, the pin shaft, and pin head, to the second hinge leaf plate, which are to be considered apparent and obvious to the disclosure.

Additionally, in alternate embodiments, it is anticipated that the second hinge leaf plate 20 may be manufactured with circular opening(s), or hole(s), therethrough, which allow for the pass through and connection of the aforementioned mechanical connectors or fasteners used to connect or fasten the rack attachment pin 50, or related components, the pin shaft 55, and pin head 60, to the second hinge leaf plate 20 in a manner which results in a rack attachment hinge 10 that accomplishes the same purpose and function of the invention disclosed herein.

It is to be understood that the rack attachment pin(s) 50 of the invention are intended to be inserted into the openings on the face of the vertical legs 80 of a storage rack 70 or storage rack system. In the preferred embodiment of the invention, the second hinge leaf plate 20 comprises first and second rack attachment pins 50, disposed apart from each other generally a distance equal to the distance between corresponding first and second openings 75 in the vertical rack support leg 80 face.

It is to be further understood that the rack attachment pin 50, and related pin shaft 55 and pin head 60, of the hinge leaf plate 20 can be embodied or shaped to interface with and connect with, a variety of different corresponding rack support leg opening 75 shapes including but not limited in use to cylindrical, triangular, trapezoidal, square, oval, circular, rectangular, hexagonal, and other shapes not included herein which are to be considered apparent and obvious to the disclosure. Additionally, the pin shaft 55 may further be embodied to have a shape along the length or profile of the shaft 55 such as cylindrical, triangular, trapezoidal, square, oval, circular, rectangular, hexagonal, or other shape, and further comprise “anti-rotation” features on the shaft left and right sides including beveled, flat, angled, flared or other feature that is notched or otherwise embodied in the pin shaft 55 to prevent the pin shaft 55 from rotating when in the installed position in the vertical rack support leg opening 75.

It is to be further understood that the rack attachment pin 50, and related pin shaft 55 and pin head 60, of the second hinge leaf plate 20 can be embodied to receive a material such as a gasket 33, grommet, sleeve, coating, adhesive or other material, to create a better more secure interface between the pin shaft, pin head, hinge leaf plate, and or rack support leg.

It is to be further understood that alternate embodiments of the present invention may comprise a single continuous hinge 85 having a multitude of rack attachment pins 50 arrayed along the length of the second hinge leaf plate 20, disposed apart from each other generally a distance equal to the distance between the corresponding multitude of openings 75 in the vertical rack support leg 80 face. This embodiment is referred to as the “continuous hinge” embodiment of the invention.

The preferred embodiment of the invention comprises a second hinge leaf plate 20 having first and second rack attachment pins 50. However, one alternate embodiment of the invention comprises a second hinge leaf plate 20 having a single rack attachment pin 50. Another alternate embodiment of the invention comprises a second hinge leaf plate 20 having first, second, and third rack attachment pins 50. Another alternate embodiment of the invention comprises a second hinge leaf plate 20 having a length equal to a corresponding length on a rack support leg 80, and a multitude of rack attachment pins 50.

Another alternate embodiment of the invention comprises first hinge leaf plate 15 and second hinge leaf plate 20, each leaf plate comprising one or more rack attachment pins 50, at least one knuckle 35, and a multitude of screw holes therethrough. This embodiment of the invention enables a user to attach a first door 85 or panel to the first hinge leaf plate by means of inserting screws or fasteners through the multitude of screw holes into the first door 85 or panel, then to further attach a second door or panel to the second hinge leaf plate by means of inserting screws or fasteners through the multitude of screw holes into the second door or panel. This embodiment of the invention further allows for the first door 85 or panel to be attached to, mounted to, or otherwise hung on a corresponding first face of the storage rack 70, and the second door or panel to be attached to, mounted to, or otherwise hung on a corresponding second face of the storage rack, whereby the first and second faces of the storage rack can be co-planar to each other, or perpendicular to each other, thereby forming a corner whereon the first or second door or panel hinges.

It is intended that the present invention may be used to secure panels or covers in place on a storage rack or storage rack system without requiring or utilizing the purpose or function of the hinging aspect of the invention. This alternate embodiment of the invention comprises a single non-hinging rack attachment pin plate 22. Said plate comprising one or more rack attachment pins 50 and a multitude of fastener holes 40 through said plate. This embodiment of the invention allows a user to attach the rack attachment pin plate 22 to a panel by inserting fasteners, such as screws, through the rack attachment pin plate and into the panel, thereby securing the plate in a fixed position. The panel can then be secured into position on the storage rack or storage rack system by inserting the rack attachment pin head (male) through an opening 75 (female) embodied in, and arrayed along the length of, the rack support leg 80 surfaces. It is to be understood that one, or a multitude of rack attachment pin plates can be fastened to a panel to support and secure the panel in position on the storage rack or storage rack system.

An alternate embodiment of the invention comprises a main hinge body from the preferred embodiment, and a hinge mounting plate. Said hinge mounting plate comprising at least one opening (female) for receiving the rack attachment pin head and shaft of the main hinge body, a multitude of fastener holes which allow for fastening of the hinge mounting plate to a frame, wall, jamb, or other structure.

It is anticipated that alternate embodiments of the invention disclosed herein comprises rack attachment pins having a “hook” or inverted “U” shape, thereby allowing the rack attachment pin to be inserted through an opening (female) embodied in, and arrayed along the length of, the rack support leg surfaces. This embodiment acts to hang the rack attachment pin of the main hinge body on the rack support leg.

It is further anticipated that the present invention, in an alternate embodiment, comprises a separate hinge mounting plate having at least one rack attachment pin, a main hinge body, said main hinge body further comprising first and second hinge leaf plates, a hinge barrel, and a hinge pin. Said first hinge leaf plate having a generally flat rectangular shape typical of common hinge leaf plates. Said first hinge leaf plate further comprising at least one knuckle, and a multitude of circular openings, or holes, said knuckle having a generally cylindrical shape disposed generally along a length of one side of the generally flat rectangular hinge leaf plate, said multitude of circular openings, or holes, being generally disposed within the perimeter of the generally flat rectangular hinge leaf plate, said openings are intended to allow for the passthrough of fasteners commonly used to attach a hinge leaf plate to a door, frame, panel, cover or other object or material intended to be operated with the hinge. Said second hinge leaf plate having a generally flat rectangular shape typical of common hinge leaf plates. Said second hinge leaf plate further comprising at least one knuckle, and at least one rack pin insertion opening (female), said knuckle having a generally cylindrical shape disposed generally along a length of one side of the flat rectangular leaf plate, whereby the knuckle of the said first hinge leaf plate and the knuckle of the said second hinge leaf plate, interconnect to form said hinge barrel, through which the hinge pin is inserted to pivotally interconnect said first and second hinge leaf plates. Said rack pin insertion opening through the second hinge leaf plate, being generally centrally disposed, having a shape intended for receiving a corresponding rack attachment pin head and shaft of the separate hinge mounting plate. Further, the rack attachment pin, of the separate hinge mounting plate, generally comprising a pin shaft and a pin head, said pin shaft protrudes from the generally planar back surface of the separate hinge mounting plate a distance sufficient to dispose the pin head from the hinge leaf plate back surface, said pin shaft having, in the preferred embodiment, a generally cylindrical shape, said pin head having, in the preferred embodiment, a generally cylindrical shape, said pin head further having a diameter greater than the diameter of the pin shaft. This embodiment allows a user to insert, from the back side, the separate hinge mounting plate rack attachment pin(s) through the corresponding opening(s), (female), embodied in, and arrayed along the length of, the rack support leg surfaces. The user would then further insert the separate hinge mounting plate rack attachment pin(s) through the rack pin insertion opening(s) of the second hinge leaf plate. This effectively sandwiches the rack support leg surface between the separate hinge mounting plate and the second hinge leaf plate of the main hinge body, thereby attaching or hanging any door or panel connected to the main hinge body.

It is to be understood that the hinge pin aspect of the present invention disclosed herein is also intended to be embodied on a variety of hooks, hangers, bars, clamps, and other holders or retention systems not referred to herein which can have the pin fastened, welded, or otherwise attached to a front or back face to allow for attachment to a rack leg. This includes holders or retention systems used for holding or retaining gardening or yard tools such as brooms, shovels, rakes, hoes, by means of hooks, nails, pins, wires, loops, clamps, or pressure clips commonly used for this purpose. It is intended that one or a multitude of the rack pin(s) be mounted fastened or otherwise attached to the back or front face of any hook, clamp, bar, hanger, strap, or other hanger or retention unit and thereby allowing them to be attached to one or multiple rack legs of a rack storage system.

It is further anticipated that an alternate embodiment of the invention comprises the main invention described in the preferred embodiment, one or a multitude of sliding door panels, a top slide rail, and a bottom slide rail, with said sliding door panels further comprising sliding components typically used with common sliding door hardware including but not limited in use to, wheels, balls, glides, rails, tracks, or other sliding door hardware which performs the same purpose and function and is to be considered apparent and obvious to the disclosure contained herein. The sliding door rail or track is intended to fasten to the second hinge leaf plate in a manner similar to the preferred embodiment describe herein.

It is anticipated that any of the embodiments of the invention disclosed herein may comprise security and or safety features that prevent accidental or intentional removal of the rack attachment pin from a secured position in a corresponding opening of a rack support leg, after it has been installed. Security features may include lockable features that prevent the removal of a rack attachment pin from a corresponding opening in a rack support leg. Security features may further prevent the removal of hinge pins from the hinge barrel. Security features may further comprise metal bar(s) that span the opening from, and securely connect to, one door main hinge body to a second door main hinge body, said metal bar(s) further allowing for a locking device to be initiated from outside the door(s) once they are in the closed position, thereby attaching the door(s) to the metal bar(s).

The system components disclosed herein are intended to be manufactured from metal, however other materials may be used including but not limited to, metal alloy, plastic, polymer, or similar materials which may be represented in a variety of types and composition mixes having various combinations of ingredients such as those found in the manufacture of metal alloys, plastics, polymers, which when combined will create the material used to manufacture the invention disclosed herein and is therefore to be considered apparent and obvious to the disclosure. The invention may also embody a wide variety of different finishes, colors, and textures such as those commonly utilized in the metal fabrication and finishing industries.

The foregoing has outlined, in general, the physical aspects and the intended use and function of the invention and is to serve as an aid to better understanding the invention disclosed herein. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention.

FIG. 1. Shows a Main hinge body, partially open, having a first hinge leaf plate with fastener holes, and a second hinge leaf plate with first and second rack attachment pins, a hinge barrel, and hinge pin.

FIG. 2. Shows a Main hinge body, closed, having a first hinge leaf plate, and a second hinge leaf plate with first and second rack attachment pins, a hinge barrel, and hinge pin.

FIG. 3. Shows a Main hinge body, fully open, having a first hinge leaf plate with fastener holes, and a second hinge leaf plate with first and second rack attachment pins, a hinge barrel, and hinge pin.

FIG. 4. Shows a Main hinge body, fully open, having a first hinge leaf plate with fastener holes, and a second hinge leaf plate with a partially visible rack attachment pin, a hinge barrel, and hinge pin.

FIG. 5. Shows a Render showing main hinge body and a rack support leg in the uninstalled position.

FIG. 6. Shows a Render showing main hinge body and a rack support leg with the rack attachment pins inserted through the openings (female) in the rack support leg in the installed position.

FIG. 7. Shows a Render showing (1) assembled storage rack, (4) main hinge bodies, and (2) open doors, with the main hinge bodies fastened to the doors and mounted into the rack support legs in the installed position.

FIG. 8. Shows a Render showing (1) assembled storage rack and (2) closed doors in the installed position.

FIG. 9. Shows a Render showing a separate hinge mounting plate having (2) rack attachment pins, a rack support leg with multiple rack pin insertion openings, a main hinge body, fully open, comprising a first hinge leaf plate with (4) fastener holes, a second hinge leaf plate with a (2) rack pin insertion openings, a hinge barrel, and hinge pin.

FIG. 10. Shows a Render showing a separate hinge mounting plate having (2) rack attachment pins, installed in a rack support leg with multiple rack pin insertion openings, a main hinge body comprising a first hinge leaf plate with (4) fastener holes, a second hinge leaf plate with a (2) rack pin insertion openings, a hinge barrel, and hinge pin, fully open and installed on the (2) rack attachment pins,

FIG. 11. Shows a Render showing a separate mounting plate having (4) fastening holes and (2) trapezoidal shaped rack pin insertion openings (female), and a main hinge body having a first hinge leaf plate with (4) fastener holes, a second hinge leaf plate with (2) rack attachment pins (male) having a trapezoidal shape.

FIG. 12. Shows a Render showing a separate mounting plate having (4) fastening holes and (2) trapezoidal shaped rack pin insertion openings (female), and a main hinge body having a first hinge leaf plate with (4) fastener holes, a second hinge leaf plate with (2) rack attachment pins (male) having a trapezoidal shape and further having a rubber gasket 33 on the rack attachment pin shaft.

FIG. 13. Shows a Render showing a separate mounting plate having (4) fastening holes and (2) rack pin insertion openings (female), and a main hinge body having a first hinge leaf plate with (4) fastener holes, a second hinge leaf plate with (2) rack attachment pins (male).

FIG. 14. Shows a Render showing a separate mounting plate having (4) fastening holes and (2) rack pin insertion openings (female), and a main hinge body having a first hinge leaf plate with (4) fastener holes, a second hinge leaf plate with (2) rack attachment pins (male) inserted into the mounting plate in the installed position.

FIG. 15. Shows a Render showing main hinge body and a rack support leg with the rack attachment pins having a trapezoidal shape inserted through the corresponding trapezoidal shaped openings (female) in the rack support leg in the installed position.

FIG. 16. Render showing sliding doors mounted to a bar header used for mounting sliding doors to a rack system.

FIG. 17. Render showing the rack attachment pins attached to a bar header used for mounting sliding doors to a rack system.

FIG. 18. Render showing the rack attachment pins attached to a bar header used for mounting sliding doors to a rack system in the installed position.

FIG. 19. Render showing the rack attachment pins attached to a bar header and bar footer used for mounting sliding doors to a rack system.

FIG. 20. Render showing sliding doors mounted to a bar header used for mounting sliding doors to a rack system.

FIG. 20. Renders showing another embodiment of a hook back embodied with the rack pin.

FIG. 21. Renders showing another embodiment of a hook back embodied with the rack pin

FIG. 22. Renders showing another embodiment of a hook back embodied with the rack pin

FIG. 23. Renders showing another embodiment of a hook back embodied with the rack pin

FIG. 24. Renders showing another embodiment of a hook back embodied with the rack pin

FIG. 25. Renders showing another embodiment of a hook back embodied with the rack pin

FIG. 26. Renders showing the rack pin having anti-rotation edges.

FIG. 27. Render showing a non-hinging rack attachment pin plate.

FIG. 28. Render showing another embodiment of a non-hinging rack attachment pin plate.

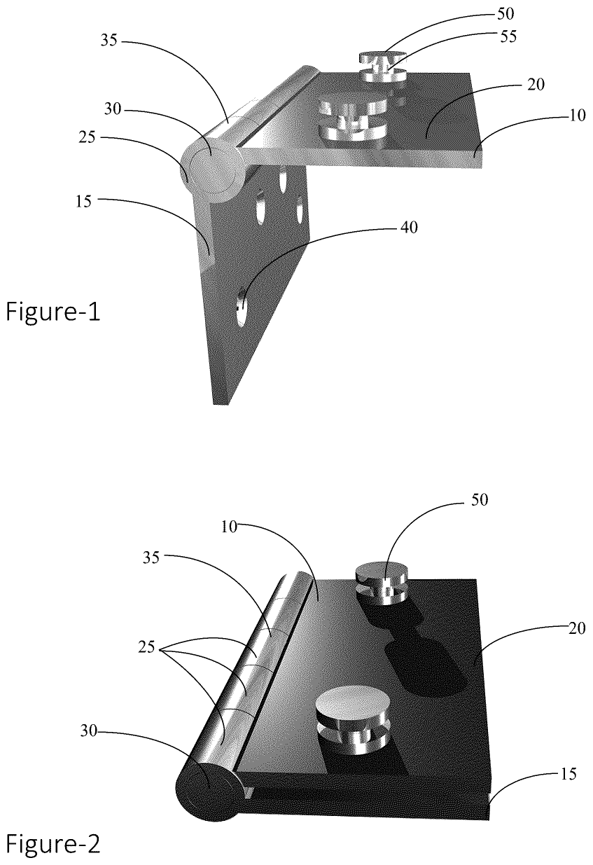

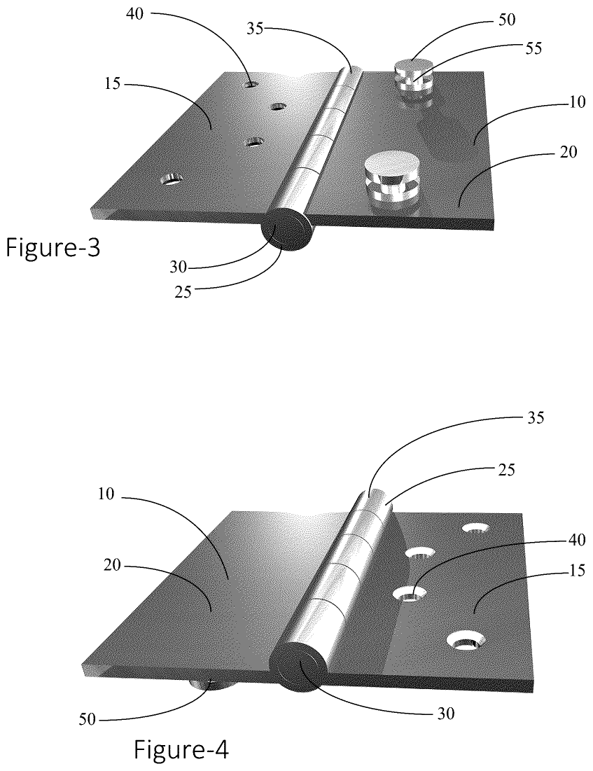

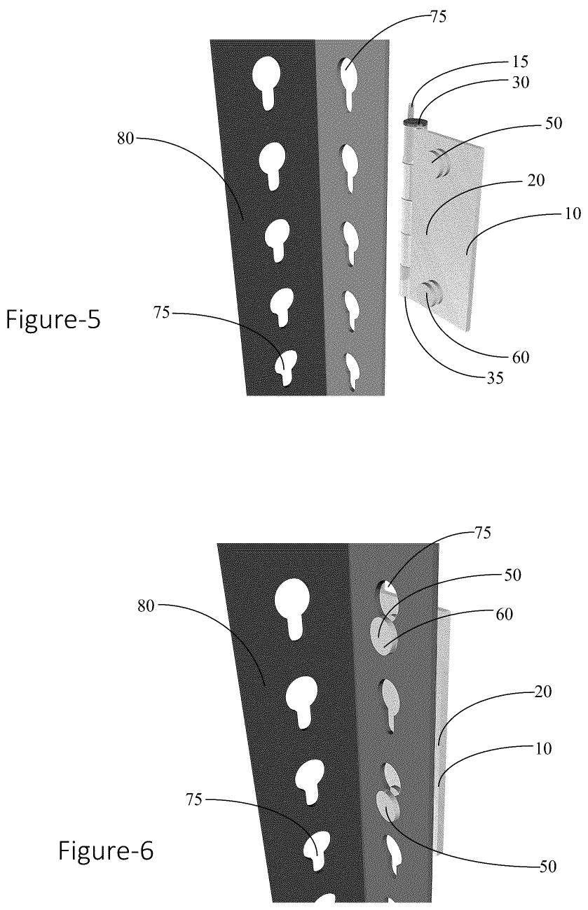

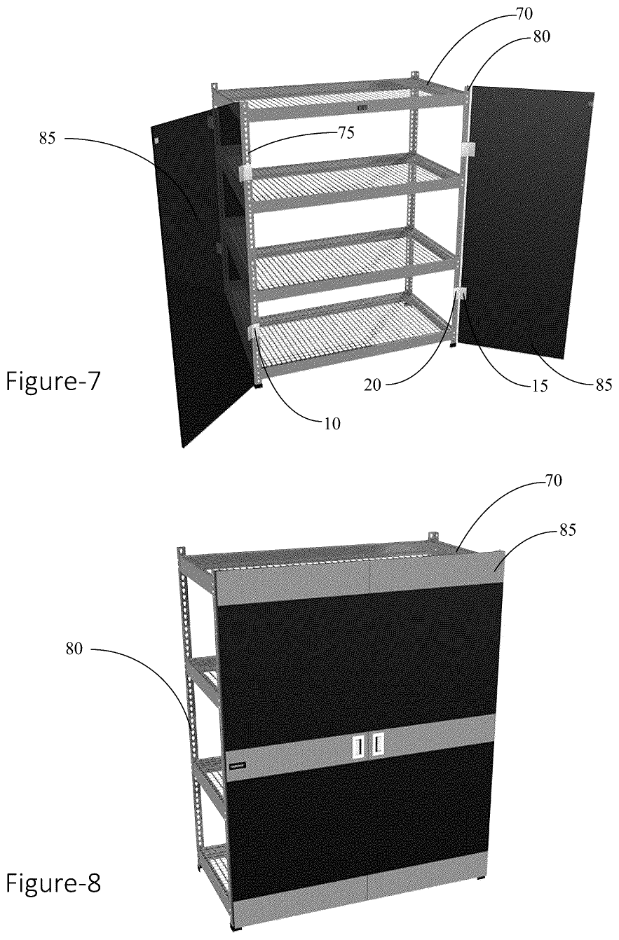

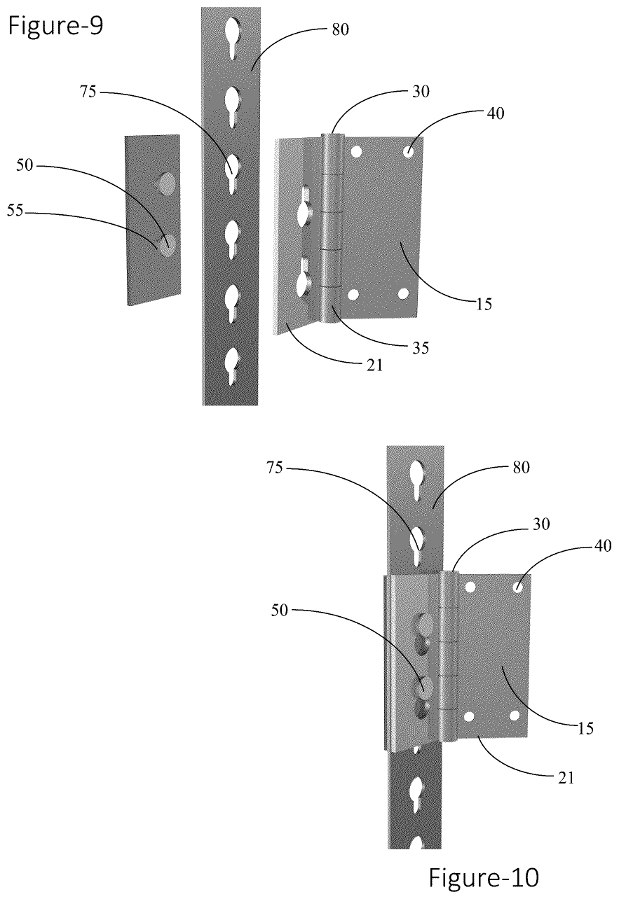

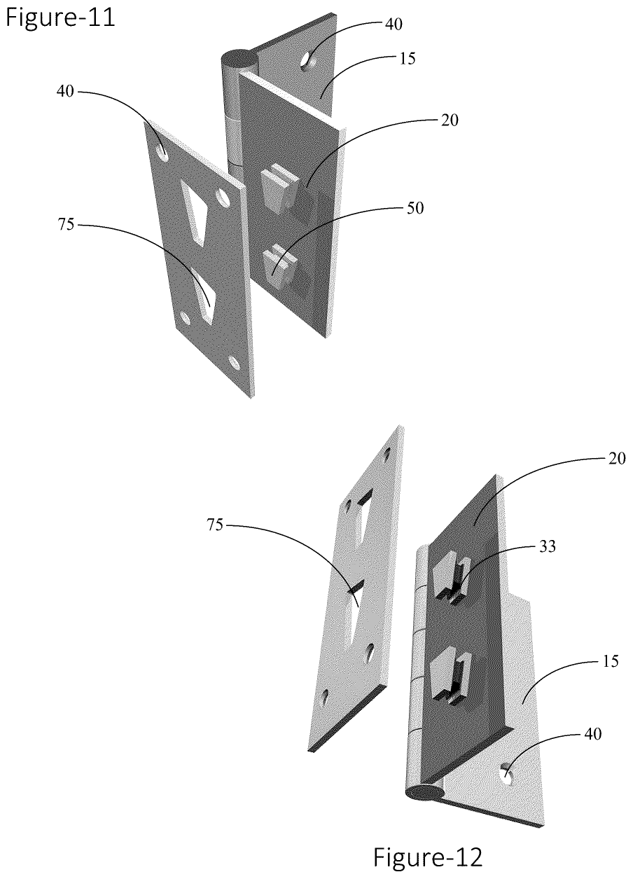

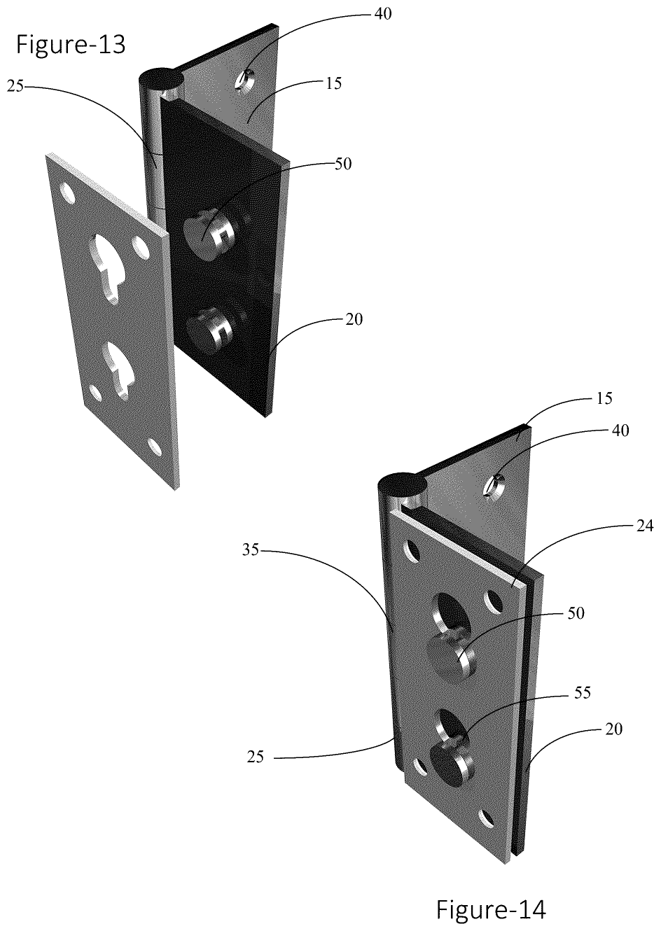

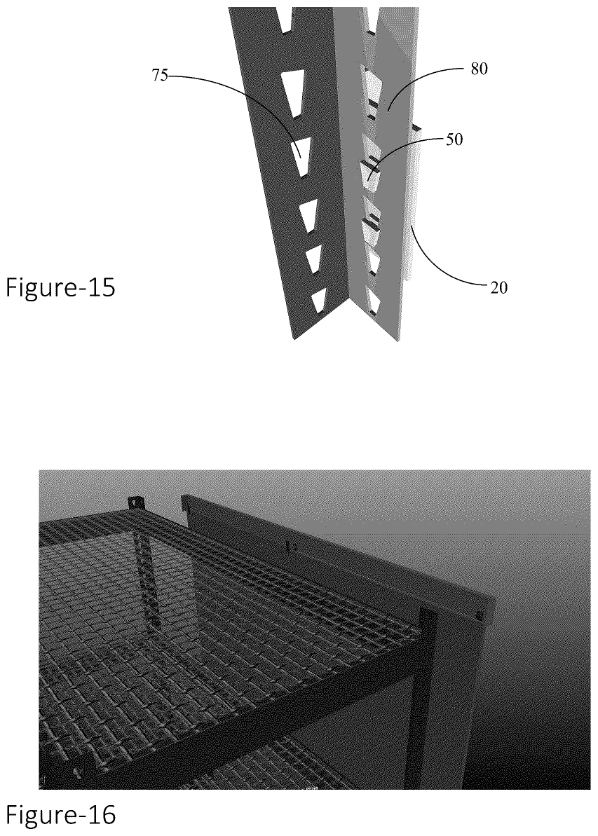

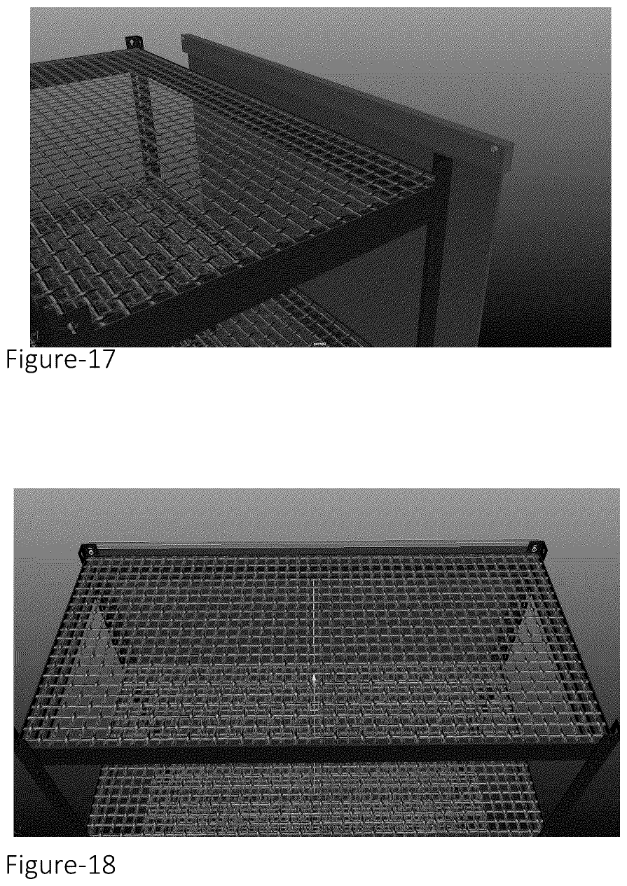

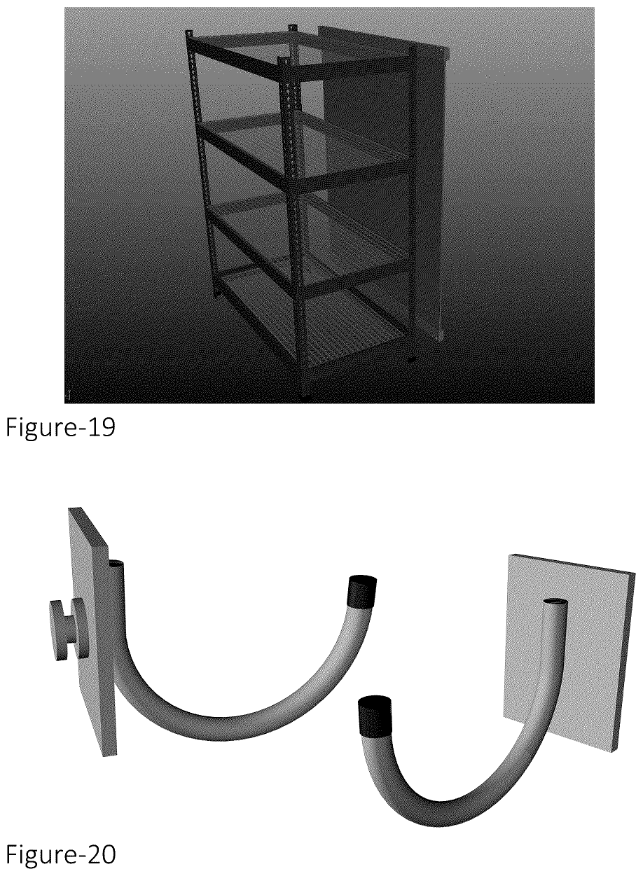

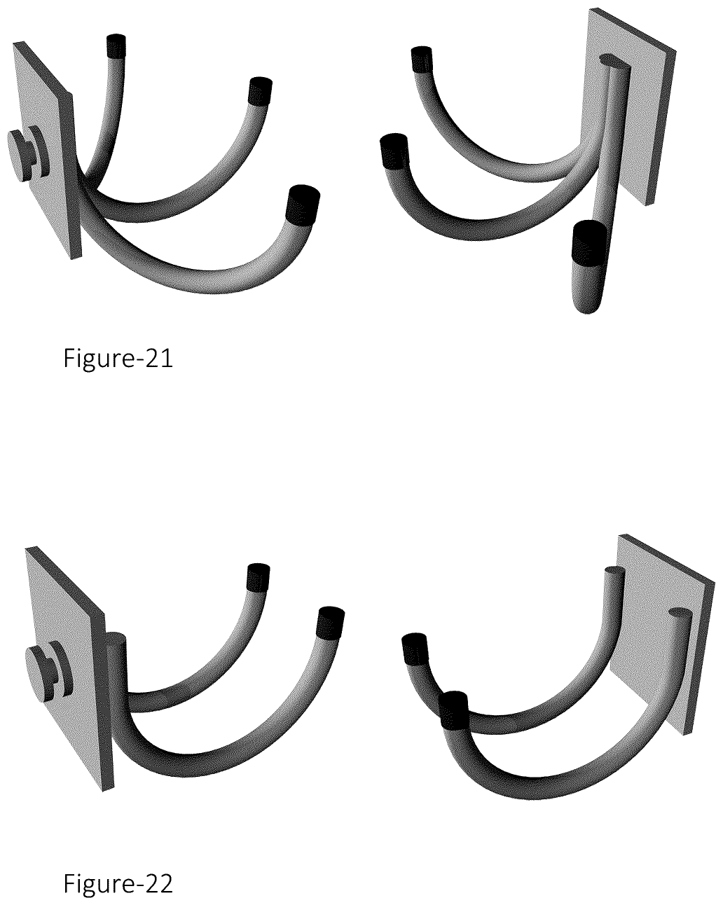

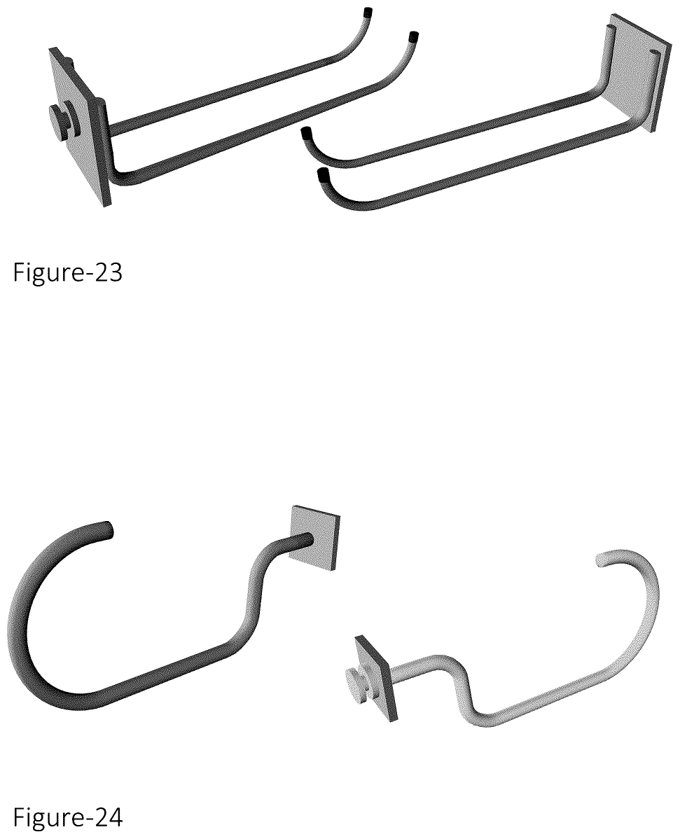

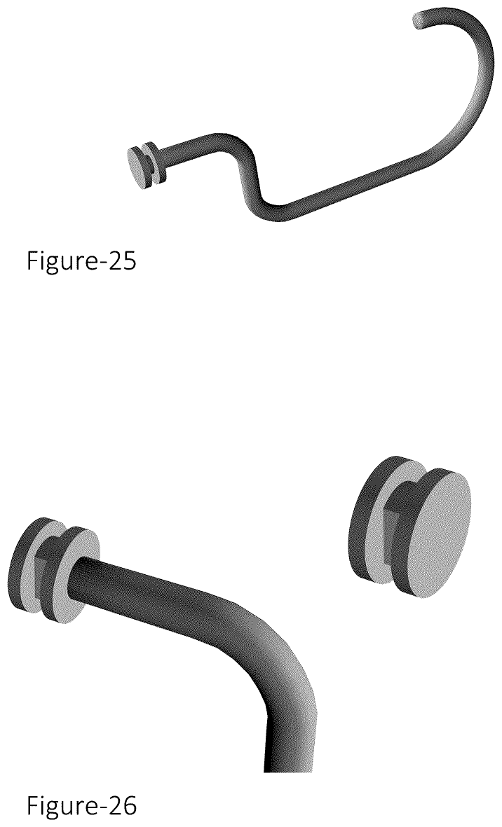

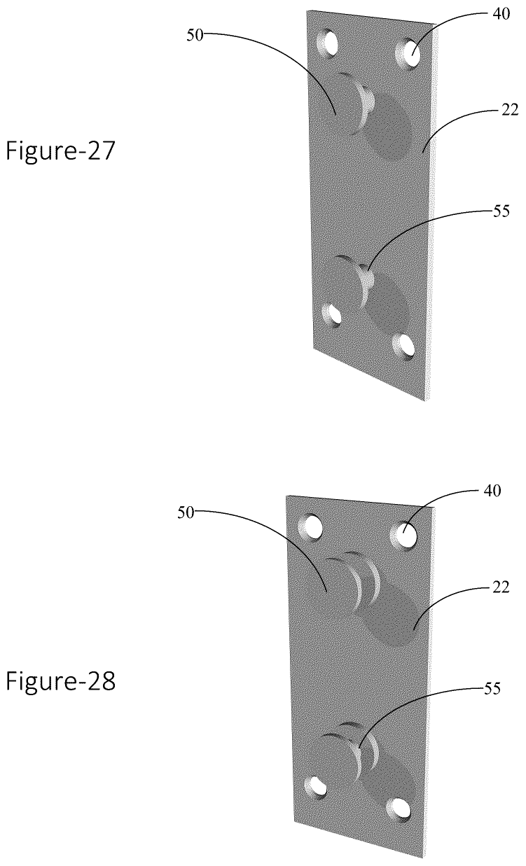

1. A hinge structure comprising:
a first hinge leaf plate, a second hinge leaf plate, and a hinge pin;
wherein said first hinge leaf plate has one or more through openings and one or more hinge leaf connecting components; wherein said second hinge leaf plate has one or more mounting pins and one or more hinge leaf connecting components; wherein said hinge leaf plates have common ends; said connecting component is comprised of at least one of the following: knuckle, loop, joint, node, curl, or flexible strip.

2. The hinge structure of claim 1 wherein;
said first hinge leaf plate has one or more mounting pins.

3. The hinge structure of claim 1 wherein;
said one or more mounting pins include a gasket.

4. A panel mounting plate structure comprising:
a first mounting plate;
wherein said mounting plate has one or more mounting pins, wherein said mounting plate has one or more through openings;

5. The panel mounting plate structure of claim 2 wherein;
said one or more mounting pins include a gasket.

6. An object holding structure comprising:
a mounting plate and an object holding structure;
wherein said mounting plate has one or more mounting pins, wherein said object holding structure is connected to said mounting plate;

7. The panel mounting plate structure of claim 3 wherein;
said one or more mounting pins include a gasket.

8. The panel mounting plate structure of claim 3 wherein;
said object mounting structure is one or more of the following: hook, bar, rod, strap, clip, angle, clamp,

9. The panel mounting plate structure of claim 3 wherein;
said one or more mounting pins attach directly to said object mounting structure.
